(19) United States
(12) Patent Application Publication
(10) Pub. No.: US 2017/0228993 A1
(43) Pub. Date: Aug. 10, 2017

(54) Detector Base For Releasably Attaching A Hazard Detector With A Radio Device For Transmitting Position Data Of The Mounting Location Of The Detector Base And/Or For Transmitting A Reference To Said Position Data

(71) Applicant: Siemens Schweiz AG, Zuerich (CH)

(72) Inventors: Bjoern Avak, Baar (CH); Christian Frey, Unteraegeri (CH); Simon Kuenzli, Winterthur (CH); Oliver Zechlin, Zug (CH)

(73) Assignee: Siemens Schweiz AG, Zuerich (CH)

(21) Appl. No.: 15/501,960

(22) PCT Filed: Jun. 29, 2015
(86) PCT No.: PCT/EP2015/064641

§ 371 Date: Feb. 6, 2017

(30) Foreign Application Priority Data
Aug. 5, 2014 (EP) 14179909.8

(51) Int. Cl. G08B 17/00; G01C 21/20; G01S 1/04; H04W 52/50

(52) U.S. Cl. CPC G08B 17/00; H04W 52/50; G01C 21/206; G01S 1/042

(57) ABSTRACT

A detector base for fixing to a mounting surface may include a connection for connecting to a detector line of a hazard alarm system and a first connection side for releasably attaching a hazard detector embodied as a point detector. The first connection side may be electrically and structurally co-ordinated with a second connection side of such a hazard detector, such that the latter is releasably attachable to the detector base and is indirectly connectable via the latter to the detector line. The detector base may include a radio device affixed to the detector base and serving for transmitting position data of the detector base mounting location and/or for transmitting a reference to a database having said position data. The radio device may be based on a Bluetooth low energy standard.

### CROSS-REFERENCE TO RELATED APPLICATIONS

This application is a U.S. National Stage Application of International Application No. PCT/EP2015/064641 filed Jun. 29, 2015, which designates the United States of America, and claims priority to EP Application No. 14179909.8 filed Aug. 5, 2014, the contents of which are hereby incorporated by reference in their entirety.

### TECHNICAL FIELD

The invention relates to a detector base for fastening to a mounting surface, typically to a ceiling. The detector base has an electrical connection for connecting the detector base to a detector line of a hazard alarm system. The detector line, which is also referred to as a detector bus, is typically embodied as a two-wire line. The detector base moreover comprises a first connection side for preferably releasably attaching a hazard detector embodied as a point detector. The first connection side is matched here electrically and structurally to a second connection side of a hazard detector of this type, so that this can preferably be releasably attached to the detector base and indirectly connected to the detector line by way of this. Detector bases of this type are widely known.

### BACKGROUND

A radio module is described in the US patent U.S. Pat. No. 7,973,669 B2, which has a printed circuit board, a radio unit for transmitting position information and a power supply. The printed circuit board is dimensioned such that it can be inserted between a detector base and a hazard detector to be accommodated. The printed circuit board has opposing contact surfaces which are provided on the one hand in order to make contact with contacts of the detector base and on the other hand to make contact with the otherwise opposing contacts of the hazard detector. On account of the opposing contacts of the printed circuit board, after the hazard detector has been fastened to the detector base, the radio module is electrically connected between the two. This means that in addition to looping through the signals and the power supply from the detector base to the accommodated hazard detector, power can be supplied to the radio module.

### SUMMARY

One embodiment provides a detector base for fastening to a mounting surface, having an electrical connection for connecting the detector base to a detector line of a hazard alarm system and having a first connection side for releasably attaching a hazard detector embodied as a point detector, wherein the first connection side is electrically and structurally matched to a second connection side of a hazard detector of this type so that this can be releasably attached to the detector base and by way hereof can be indirectly connected to the detector line, wherein the detector base has a radio device accommodated in particular fixedly in the detector base for transmitting position data of the mounting location of the detector base and/or for transmitting a reference to a database with this position data.

In one embodiment, the detector base has an optical and/or acoustic alarm unit which can be triggered by way of the detector line via a signal or data link.

In one embodiment, the detector base is embodied to supply electrical energy to the radio device by way of the detector line.

In one embodiment, the detector base has an energy store for buffering the electrical power supply of the radio device.

In one embodiment, the radio device is a Bluetooth radio device, in particular based on a Bluetooth low energy standard.

In one embodiment, the detector base is designed to detect a signaling of a hazard alarm, in particular a fire alarm, on the detector line and then to activate the radio device with a higher mean transmission power.

In one embodiment, the radio device can be activated with a maximum transmission power of 10 mW, 25 mW, 50 mW or 100 mW.

In one embodiment, the detector base has a circuit carrier with a large-surface ground plane as a radio-based part of the radio device, wherein the radio device has radio electronics preferably arranged on the circuit carrier and a ring-shaped antenna arranged at a distance from the ground plane, and wherein after the detector base has been conventionally attached to the mounting surface, the antenna is further away from the mounting surface than the ground plane of the circuit carrier.

In one embodiment, after accommodating a conventionally provided hazard detector the detector base has a larger outside diameter than the accommodated hazard detector and wherein the radio device has at least one antenna arranged in the detector base and lying radially further outside compared with the accommodated hazard detector.

In one embodiment, the antenna is formed to be ring-shaped.

In one embodiment, the detector base has a circuit carrier with a large-surface ground plane as a radio-based part of the radio device, wherein the radio device has radio electronics preferably arranged on the circuit carrier, wherein the ring-shaped antenna is arranged at a distance from the ground plane, and wherein after the detector base has been conventionally attached to the mounting surface, the antenna is further away from the mounting surface than the ground plane of the circuit carrier.

In one embodiment, the ring-shaped antenna is a PIF antenna.

In one embodiment, the detector base has a control unit connected to the radio device via a signal and/or data link, wherein the position data, a reference to a database with this position data, an identifier specific to the detector base and/or a web address are stored in the control unit, and wherein the control unit is designed to forward this for outputting via radio to the radio device.

In one embodiment, the detector base has a control unit connected to the radio device via a signal and/or data link, which is designed to check the validity of position data received by way of the radio device, a received reference to a database with this position data and/or a received web address and if valid, to store this in the control unit or in the storage device connected thereto.

### BRIEF DESCRIPTION OF THE DRAWINGS

Example aspecs and embodiments of the invention are explained in detail below with reference to the figures, in which:

FIG. 1 shows an example embodiment of an inventive detector base for releasably accommodating a smoke detector or alarm device provided therefor as a hazard detector; and

FIG. 2 shows a further example embodiment of an inventive detector base with an integrated optical and acoustic alarm unit.

### DETAILED DESCRIPTION

Embodiments of the invention provide a detector base with enhanced functionality.

In some embodiments, the detector base has a radio device for transmitting position data of the mounting location of the detector base and/or for transmitting a reference to a database with this position data. The radio device is in particular fixedly accommodated in the detector base.

Preferably the radio device is electrically connected or can subsequently be electrically connected to a terminal plug of the detector base, which is provided to connect the detector base to the detector line. After connection the radio device is thus an integral part of the detector base itself and forms a structural unit herewith.

An inventive aspect lies in the transmitted position data and/or the reference thereto being assigned to the fixed-location detector base and consequently also to the fixed mounting location.

As a result, hazard detectors accommodated on the inventive detector base can advantageously be exchanged, without the transmitted position data of the mounting location and/or the reference thereto changing.

A further major advantage is the simple retrofitting of an existing hazard alarm system.

In contrast, the transmitted position data in known hazard detectors with a radio device is linked to the respective hazard detector. When the hazard detector is replaced or its location changed, the transmitted position data no longer matches the position data of the new mounting location. As a result, a disadvantageously erroneous or restricted position determination and navigation of a user in a building is possible, in particular in a hazardous situation.

Also with the proposed solution according to U.S. Pat. No. 7,973,669 B2 cited in the introduction, there is the possibility of an erroneous position specification, such as e.g. the mounting location, being output since the radio module printed circuit board to be inserted between a detector base and a hazard detector to be accommodated is not structurally fixedly assigned to a detector base or a hazard detector. If e.g. within the scope of an overhaul, a series of hazard detectors is serviced, e.g. cleaned or calibrated, the printed circuit boards can easily be inadvertently swapped when the printed circuit boards are reinserted into the hazard detectors. Furthermore, there is the risk of the serviced hazard detectors now no longer being attached to the same detector base, but instead to another detector base. As a result, the transmitted position information also changes disadvantageously. However, when a hazard detector is exchanged a printed circuit board with the radio module can also easily fall out, become faulty and then be replaced by another printed circuit board with other stored position information. In this case the transmitted position information also changes disadvantageously.

The position data can be absolute GPS coordinates for instance. It can also be relative GPS coordinates, which relate to an absolute reference GPS coordinate as a reference point, such as e.g. to the main entrance of the building or to a corner of a building. This absolute reference GPS coordinate is then to be taken into consideration by the mobile communication terminal. The position data preferably comprises all three spatial coordinates, so that each position on each floor of a building can be mapped.

The position data is thus a mapping of the local “physical” building coordinates of the current mounting location of the detector base via a data link. The latter can be derived from a BIM system (Building Information Modeling) for instance. A system of this type serves to provide an inventory of all electrical and air-conditioning components in a building. It also comprises the functional relationships of the components with one another and their spatial relationships.

The reference may be what is known as a URI (Uniform Resource Identifier), which identifies an abstract or physical resource in the Internet. A resource of this type may be a URL (Uniform Resource Locator) or a web address for instance. In particular, this reference refers to a database which can be reached via a data link by way of the Internet or an intranet. The actual position data can then be retrieved in the database for the respective reference. In the simplest case the database is a table. This database can then be reached by a mobile Internet-capable communication terminal, such as e.g. by way of a WLAN data connection in the building and/or by way of a mobile radio network which can be reached in the building. The database can alternatively also be stored in the mobile communication terminal.

Alternatively or in addition, an identifier specific to the detector base can be stored in the control unit, such as e.g. an ID, a bus address or serial number, by way of which the actual position data can then be referenced. A database with the actual position data can alternatively also be referenced by way of the identifier specific to the detector base. The database can in turn be stored in the mobile communication terminal itself or referenced by means of an Internet-capable mobile communication terminal by way of the Internet or by way of an intranet.

In accordance with a further embodiment, the inventive detector base has an optical and/or acoustic alarm unit which can be triggered by way of the detector line via a signal or data link. The optical alarm unit may be an LED or xenon alarm beacon. Optical alarm units of this type are also referred to as a “beacon base”. The acoustic alarm unit may be what is known as a sounder for instance. The latter can alternatively or in addition be embodied to output speech. Acoustic alarm units of this type are also referred to as a “sounder base”. Combinations comprising optical and acoustic alarm units are also referred to as a “sounder beacon base”.

According to a preferred embodiment, the detector base is embodied to supply electrical energy to the radio device by way of the detector line. After the detector base has been connected to the detector line similarly in order to supply electrical power to the radio device, the radio device is thus connected to the detector line.

Alternatively or in addition the inventive detector base can have an energy store for buffering the electrical power supply, such as e.g. a capacitor, a battery as a primary cell and/or a rechargeable battery as a secondary cell. As a result, an uninterruptible power supply and an operation of the radio device also remain possible in the event of an electrical failure of the detector line.

According to a particularly advantageous embodiment, the radio device is a Bluetooth radio device. It is based in particular on the Bluetooth low energy standard. An alternative common name for the Bluetooth low energy standard is the Bluetooth 4.0 standard. The particular advantage here is the comparatively very low mean electrical power of less than 50 mW, in particular of less than 10 mW, required to operate the radio device. The maximum radio transmission power preferably amounts to 2.5 mW. The hazard detectors connected to a detector line of a hazard alarm system are especially configured for a very low power consumption of typically less than 100 mW, especially as up to 100 hazard detectors and more can be connected simultaneously to a detector line.

The radio device of the inventive detector base based on the Bluetooth low energy standard permits a data communication within a radius of the radio device of up to 10 m. On the basis of the plurality of hazard detectors attached and spatially distributed in a building, or here the detector base, an extensive spatial coverage for position determination and navigation in a building is then advantageously possible.

According to one embodiment the inventive detector base can be designed to detect a signaling of a hazard alarm, such as e.g. a fire alarm, on the detector line and then to activate the radio device with a higher mean transmission power, such as e.g. with a maximum transmission power of 10 mW, 25 mW, 50 mW or 100 mW. As a result, for emergency forces, like e.g. for the fire department, a more reliable position determination and navigation in the building is possible using correspondingly suitable mobile communication terminals.

According to a further embodiment of the inventive detector base, this has a circuit carrier, in particular a printed circuit board (PCB), with a large-surface ground plane as a radio-based part of the radio device. The radio device has radio electronics arranged preferably on the circuit carrier and an antenna formed to be ring-shaped and arranged at a distance from the ground plane. Here, in accordance with the conventional attachment of the detector base to the mounting surface, the antenna is further away from the mounting surface than the ground plane of the circuit carrier. A particularly effective radio emission which is directed towards all sides is possible on the one hand due to the antenna arranged at a distance from the ground plane. As a result, a particularly good radio-based detection is advantageously possible by means of a mobile communication terminal for position determination and navigation by a user. The ring-shaped antenna is preferably a PIF antenna.

In accordance with a further embodiment, after accommodating a conventionally provided hazard detector, the detector base has a larger outside diameter than the accommodated hazard detector. The radio device has at least one antenna arranged in the detector base and lying radially further outside by comparison with the accommodated hazard detector. An improved radio emission away from the accommodated hazard detector is possible due to the antenna or antennas lying further outside.

The antenna is preferably formed to be ring-shaped. A 360° emission is possible as a result.

It is particularly advantageous if the detector base has a circuit carrier with a large-surface ground plane as a radio-based part of the radio device. The radio device then preferably has radio electronics arranged on the circuit carrier, wherein the ring-shaped antenna is arranged at a distance from the ground plane. In accordance with the conventional attachment of the detector base to the mounting surface, the antenna is further away from the mounting surface than the ground plane of the circuit carrier. A 360° emission with a high antenna gain is possible due to the arrangement at a distance from the ground plane. In particular, the ring-shaped antenna is a PIF antenna.

In accordance with a preferred embodiment, the detector base has a control unit which is connected to the radio device via a signal and/or data link. The position data, a reference to a database with this position data, an identifier specific to the detector base and/or a web address are stored in the control unit, preferably in a microcontroller. They are each assigned to the current or intended mounting location in the building. The control unit is designed to forward this for outputting via radio to the radio device. The position data, the reference, the identifier specific to the detector base and/or the web address can alternatively also be stored in an electronic storage device of the detector base, which can be accessed by the control unit via a data link.

According to one embodiment, the detector base has a control unit connected to the radio device via a signal and/or data link, which is designed to check the validity of the position data received by way of the radio device, a received reference to a database with this position data and/or a received web address and if valid, to save this in the control unit. As a result, an assignment of the current intended mounting location of the detector base via a data link is advantageously easily possible. The assignment can take place using a corresponding communication terminal for instance, e.g. a smart phone, a tablet computer or a notebook.

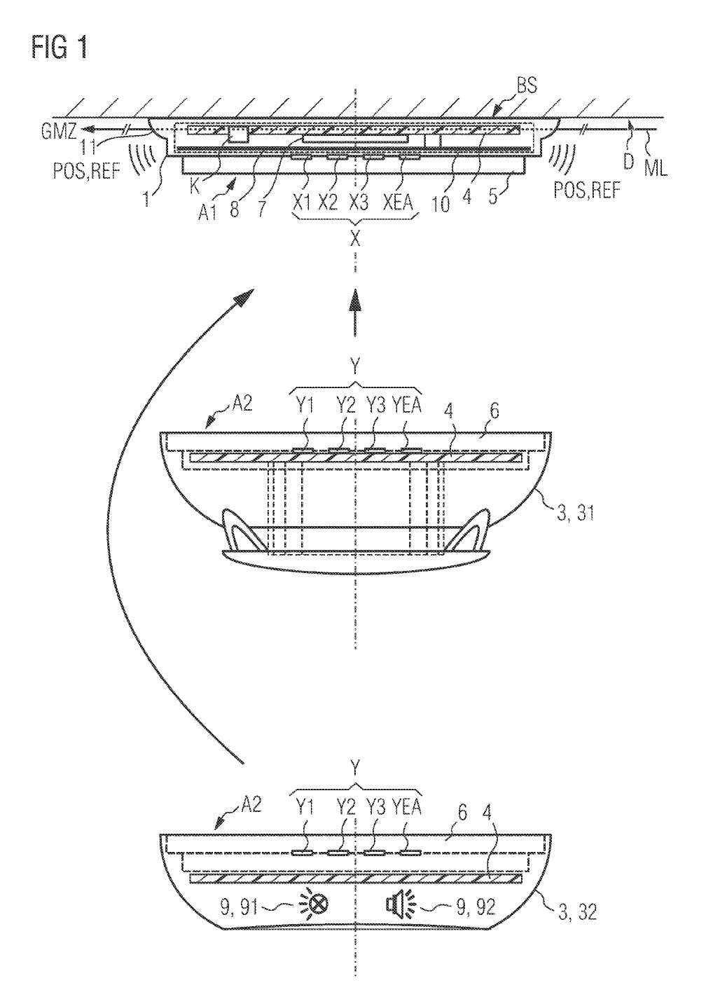

FIG. 1 shows an example of an inventive detector base 1 for releasably accommodating a smoke detector 31 or alarm device 32 provided therefor as a hazard detector 3.

The detector base 1 shown is attached to a ceiling as the mounting surface D. The fastening side which is opposite to the mounting surface D is referred to with BS, and a housing of the detector base 1 is referred to with the reference character 11. The detector base 1 has an electrical connection K, such as e.g. a terminal, for connecting the detector base 1 to a detector line ML. The latter is connected to a control center GMZ of a hazard alarm system.

The detector base 1 shown has a first connection side A1 for releasably attaching a hazard detector 3 embodied as a point detector. In the example in FIG. 1, a smoke detector 31 or an alarm device 32 can optionally be attached to the detector base 1 by way of its respective second connection side A2. By way of example the alarm device 32 shown has both an optical alarm unit 91 and also an acoustic alarm unit 92. The first connection side Al is matched here electrically and structurally to the second connection side A2 of a hazard detector 3 to be accommodated such that this can be releasably attached to the detector base 1 and by way of this indirectly connected to the detector line ML. A receptacle of the detector base 1 is referred to with the reference character 5 and a corresponding counter piece with the reference character 6. After the hazard detector 3 has been attached, the opposing rows X, Y of electrical contacts X1-X3, XEA; Y1-Y3, YEA come into contact with one another.

In accordance with the invention, the detector base 1 has a radio device 10 for transmitting position data POS of the detector base mounting location and/or a reference REF to a database with this position data POS. The position data POS is assigned to the respective mounting location of the detector base 1. A control unit of the detector base 1 is referred to with the reference character 7. It is connected to the radio device 10 via a signal and/or data link. The latter is connected to a PIF antenna 8. The PIF antenna 8 is arranged here at a distance from a ground plane of the circuit carrier 4 (not shown further) as a radio-based part of the radio device 10.

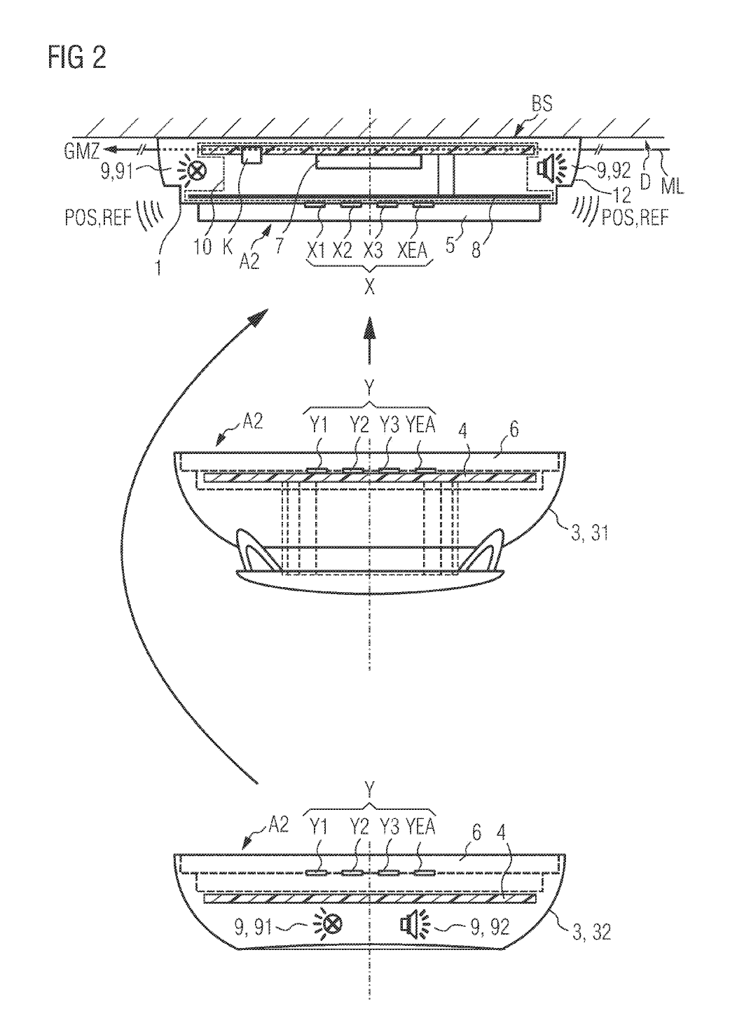

FIG. 2 shows a further example of an inventive detector base 1 with an integrated optical and acoustic alarm unit 91, 92.

FIG. 2 differs from the example in FIG. 1 in that an optical alarm unit 91 and an acoustic alarm unit 92 in the sense of a sounder beacon base are additionally integrated in the detector base 1.

### LIST OF REFERENCE CHARACTERS

1 Detector base

3 Hazard detector

4 Circuit carrier, printed circuit board

5 Receptacle

6 Counter piece to be accommodated

7 Control unit, microcontroller

8 Antenna, PIF antenna

9 Alarm unit

10 Radio device, Bluetooth transmitter

11, 12, 21 Housing

91 Optical alarm unit

92 Acoustic alarm unit, sounder

Al First connection side

A2 Second connection side

BS Fastening side

D Mounting surface, ceiling

GMZ Control center, hazard detector control center, panel

K Electrical connection, terminal

ML Detector line, detector bus, two-wire line

POS Position data, GPS coordinates

REF Reference

X Row of first electrical contacts

X Row of second electrical contacts

X1-X3, Electrical contacts

Y1-Y3,

XEA,YEA

What is claimed is:

1. A detector base for fastening to a mounting surface, the detector base comprising:
an electrical connection for connecting the detector base to a detector line of a hazard alarm system;
a first connection side for releasably attaching a hazard detector embodied as a point detector,
wherein the first connection side is electrically and structurally matched to a second connection side of the hazard detector for releasable attachment of the hazard detector to the detector base and thereby indirect connection of the hazard detector to the detector line, and
a radio device affixed in the detector base and configured to transmit at least one of position data of a mounting location of the detector base or a reference to a database with position data of the mounting location of the detector base.

2. The detector base of claim 1, further comprising an optical and/or acoustic alarm unit that is triggered via the detector line and a signal or data link.

3. The detector base of claim 1, wherein the detector base is configured to supply electrical energy to the radio device via the detector line.

4. The detector base of claim 3, comprising an energy store configured to buffer the electrical power supply of the radio device.

5. The detector base of claim 1, wherein the radio device is a Bluetooth radio device based on a Bluetooth low energy standard.

6. The detector base of claim 1, wherein the detector base is configured to detect a signaling of a fire alarm on the detector line and to activate the radio device with a higher mean transmission power.

7. The detector base of claim 6, wherein the radio device is activatable with a maximum transmission power of 10 mW, 25 mW, 50 mW or 100 mW.

8. The detector base of claim 1, comprising a circuit carrier with a large-surface ground plane as a radio-based part of the radio device,
wherein the radio device has radio electronics arranged on the circuit carrier and a ring-shaped antenna arranged at a distance from the ground plane, and
wherein when the detector base is attached to the mounting surface, the antenna is further away from the mounting surface than the ground plane of the circuit carrier.

9. The detector base of claim 1, wherein when the hazard detector is attached to the detector base, the detector base has a larger outside diameter than the attached hazard detector, and
wherein the radio device has at least one antenna arranged in the detector base and lying radially further outside compared with the accommodated hazard detector.

10. The detector base of claim 9, wherein the antenna is ring-shaped.

11. The detector base of claim 10, comprising a circuit carrier with a large-surface ground plane as a radio-based part of the radio device,
wherein the radio device has radio electronics arranged on the circuit carrier,
wherein the ring-shaped antenna is arranged at a distance from the ground plane, and
wherein when the detector base is attached to the mounting surface, the antenna is further away from the mounting surface than the ground plane of the circuit carrier.

12. The detector base of claim 8, wherein the ring-shaped antenna is a PIF antenna.

13. The detector base of claim 1, comprising a control unit connected to the radio device via at least one of a signal link or a data link,
wherein at least one of the position data, a reference to a database with this position data, an identifier specific to the detector, or a web address is/are stored in the control unit, and
wherein the control unit is configured to forward the stored data for outputting via radio to the radio device.

14. The detector base of claim 1, comprising a control unit connected to the radio device via at least one of a signal link or a data link,
wherein the control unit is configured to:
check a validity of at least one of position data received via the radio device, a received reference to a database with the position data, or a received web address, and
if the data is determined to be valid, store the data in the control unit or in the storage device connected to the control unit.
